(19) United States
(12) Patent Application Publication
(10) Pub. No.: US 2010/0064474 A1
(43) Pub. Date: Mar. 18, 2010

(54) HANDLE CAPABLE OF STORING A TOOL BIT

(76) Inventor: Chin-Tan Huang, Taichung County (TW)

Correspondence Address: SHEPPARD, MULLIN, RICHTER & HAMPTON LLP, 990 Marsh Road, Menlo Park, CA, 94025, US

(21) Appl. No.: 12/210,108

(22) Filed: Sep. 12, 2008

(51) Int. Cl. B25B 23/00

(52) U.S. Cl. 16/111.1

(57) ABSTRACT

A handle adapted for storing a tool bit therein includes a handle body and a bit retainer. The handle body has an outer surface that surrounds a longitudinal axis and that has opposite surface parts. The handle body further has a slot formed through the opposite surface parts of the outer surface of the handle body. The bit retainer is disposed in the slot of the handle body, and includes a bit receiving portion formed with at least one bit receiving hole that is adapted for insertion of the tool bit therein, and a pivot portion connected to the bit receiving portion and pivotally retained in the slot. The pivot portion is pivotable relative to the handle body about a pivot axis such that the bit receiving portion is movable relative to the handle body between a bit concealing position and a bit accessing position.

### BACKGROUND OF THE INVENTION

1. Field of the Invention

This invention relates to a handle, more particularly to a handle capable of storing a tool bit.

2. Description of the Related Art

Referring to FIG. 1, a conventional hand tool includes a handle 1 that is formed with at least one hexagonal bit receiving hole 101 adapted for insertion of a tool bit 2 therein.

The hand tool is capable of storing the tool bit 2 by virtue of the bit receiving hole 101 in the handle 1. However, the tool bit 2 is required to be fully and securely contained in the bit receiving hole 101 of the handle 1 in order to avoid any discomfort caused by extension of a tip of the tool bit 2 out of the bit receiving hole 101 when holding the handle 1. Accordingly, removal of the tool bit 2 from the bit receiving hole 101 is difficult when the tool bit 2 is more securely contained in the bit receiving hole 101. On the contrary, while removal of the tool bit 2 from the bit receiving hole 101 is easier when the tool bit 2 is less securely contained in the bit receiving hole 101, the tip of the tool bit 2 is likely to extend undesirably out of the bit receiving hole 101.

### SUMMARY OF THE INVENTION

The object of the present invention is to provide a handle that is capable of storing a tool bit and that can overcome the aforesaid drawbacks of the prior art.

According to this invention, a handle that is adapted for storing a tool bit therein includes a handle body and a bit retainer. The handle body has an outer surface that surrounds a longitudinal axis extending in a first direction and that has opposite surface parts opposite to each other in a second direction transverse to the first direction. The handle body further has a slot formed through the opposite surface parts of the outer surface of the handle body. The bit retainer is disposed in the slot of the handle body, and includes a bit receiving portion formed with at least one bit receiving hole that is adapted for insertion of the tool bit therein, and a pivot portion connected to the bit receiving portion and pivotally retained in the slot. The pivot portion is pivotable relative to the handle body about a pivot axis that extends in a third direction transverse to the first and second directions such that the bit receiving portion is movable relative to the handle body between a bit concealing position, where the bit receiving hole is concealed in the slot of the handle body, and a bit accessing position, where the bit receiving hole is accessible from the slot in the handle body.

### BRIEF DESCRIPTION OF THE DRAWINGS

Other features and advantages of the present invention will become apparent in the following detailed description of the preferred embodiment of this invention, with reference to the accompanying drawings, in which:

FIG. 1 is a perspective view of a conventional hand tool;

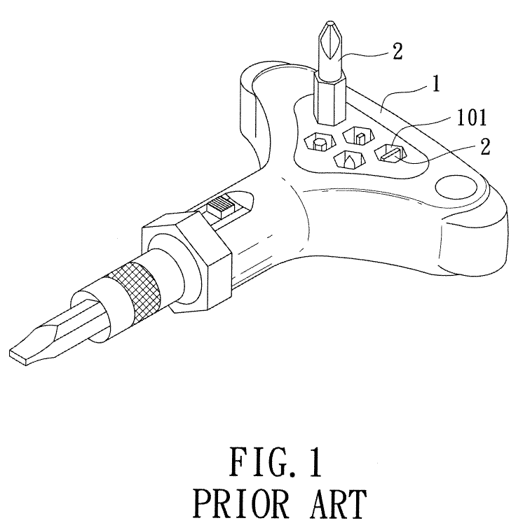

FIG. 2 is a perspective view of the preferred embodiment of a handle capable of storing a tool bit according to this invention;

FIG. 3 is an exploded perspective view of the preferred embodiment;

FIG. 4 is a schematic longitudinal view to illustrate a bit retainer disposed in a slot of a handle body according to the preferred embodiment;

FIG. 5 is a cross-sectional view that is taken along line V-V in FIG. 4 and that illustrates the bit retainer at a bit concealing position;

FIG. 6 is a view similar to FIG.5 but illustrating the bit retainer at a bit accessing position; and

FIG. 7 is a transverse cross-sectional view of the preferred embodiment taken along line VII-VII in FIG. 6.

### DETAILED DESCRIPTION OF THE PREFERRED EMBODIMENT

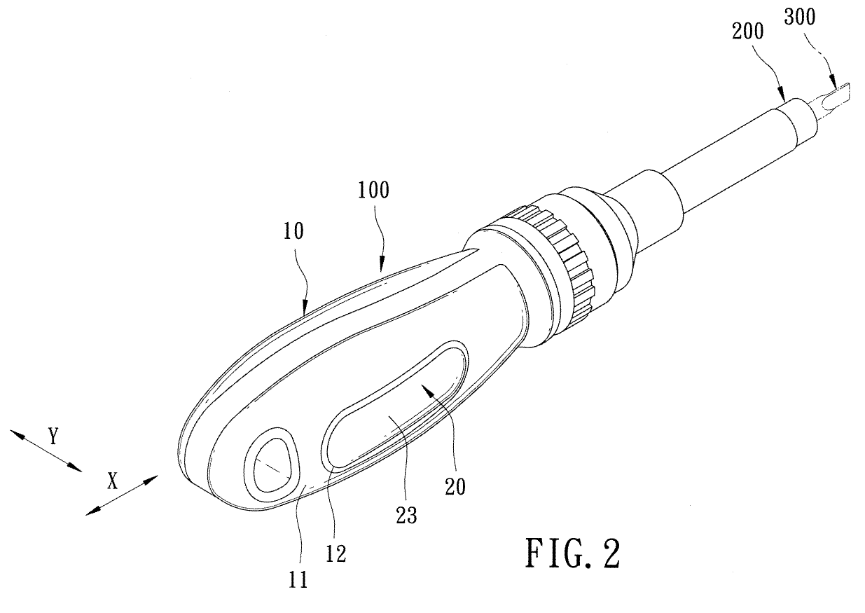

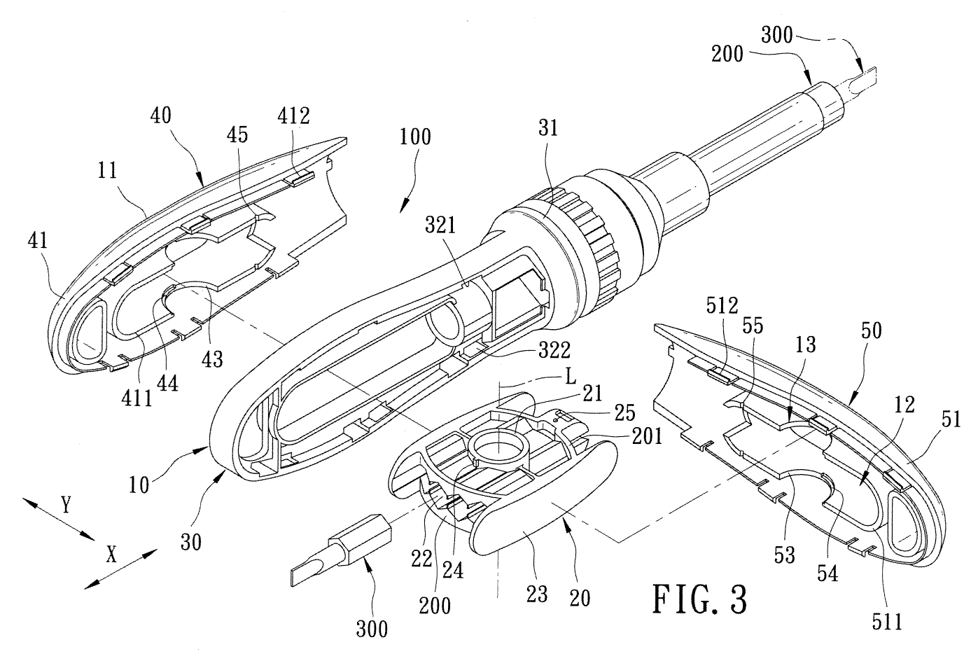

Referring to FIGS. 2 and 3, the preferred embodiment of a handle 100 adapted for storing a tool bit 300 according to the present invention is shown to include a handle body 10 and a bit retainer 20.

The handle body 10 has an outer surface 11 that surrounds a longitudinal axis extending in a first direction (X) and that has opposite surface parts opposite to each other in a second direction (Y) transverse to the first direction (X). The handle body 10 further has a slot 12 formed through the opposite surface parts of the outer surface 11 of the handle body 10.

In this embodiment, the handle body 10 includes a first case part 40 and a second case part 50 that are opposite to each other in the second direction (Y). Each of the first case part 40 and the second case part 50 includes a case wall 41,51 through which the slot 12 extends, and a pivot plate 411,511 that extends from the case wall 41,51 toward the other one of the first case part 40 and the second case part 50. The pivot plates 411,511 of the first case part 40 and the second case part 50 are oval-shaped and are formed with notches 43,53 that cooperate to confine a pivot hole 13.

The handle body 10 further includes an intermediate frame part 30 that is disposed between the first case part 40 and the second case part 50, and that is formed with a plurality of first locking members 321,322. The first case part 40 and the second case part 50 are formed with a plurality of second locking members 412,512 to engage the first locking members 321,322 and connect the first case part 40 and the second case part 50 to the intermediate frame part 30. In this embodiment, the first locking members 321,322 are holes, and the second locking members 412,512 are resilient hook parts. The outer surface 11 of the handle body 10 is cooperatively defined by outer surfaces of the intermediate frame part 30 and the case walls 41,51 of the first case part 40 and the second case part 50. It is noted herein that the first locking members 321,322 may be resilient hook parts, and the second locking members 412,512 maybe holes in other embodiments of this invention.

The handle body 10 further includes a shank coupler 31 connected to one end of the intermediate frame part 30 and adapted for connecting to a tool shank 200. The tool shank 200 has an end that is distal from the shank coupler 31, and that has a hole adapted for insertion of the tool bit 300 therein.

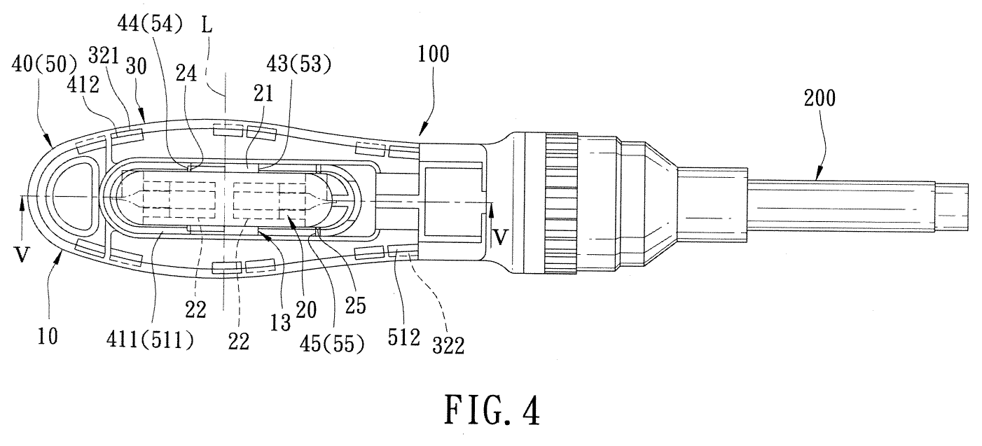

Referring to FIGS. 2, 3, and 4, the bit retainer 20 is disposed in the slot 12 of the handle body 10, and includes a first bit receiving portion 200 formed with at least one bit receiving hole 22 that is adapted for insertion of the tool bit 300 therein, and a pivot portion 21 connected to the first bit receiving portion 200 and pivotally retained in the slot 12. The pivot portion 21 of the bit retainer 20 includes a pivot shaft having opposite ends along a pivot axis (L) that extends in a third direction transverse to the first direction (X) and the second direction (Y). The opposite ends of the pivot shaft of the pivot portion 21 are pivotally retained in the pivot hole 13 that is cooperatively confined by the notches 43,53 of the pivot plates 411,511.

In an alternative embodiment, the pivot plates 411,511 may be configured to pivotally retain only one of the opposite ends of the pivot shaft of the pivot portion 21.

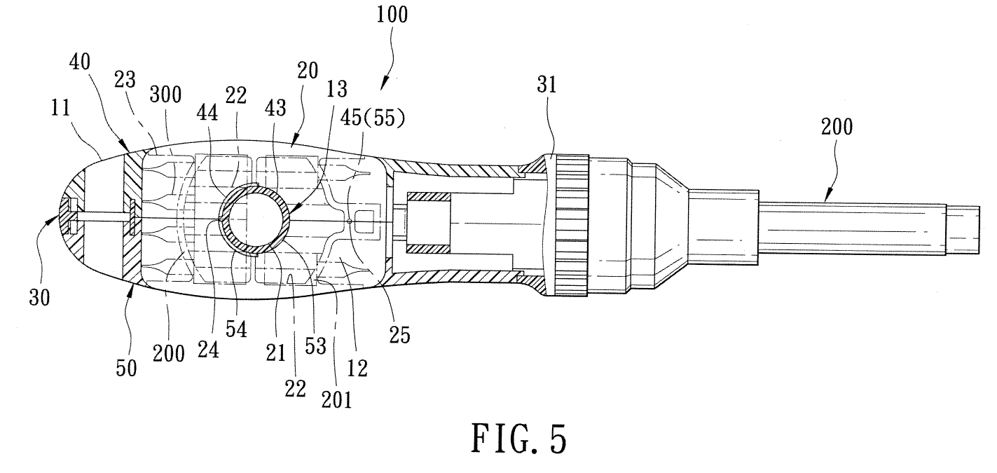

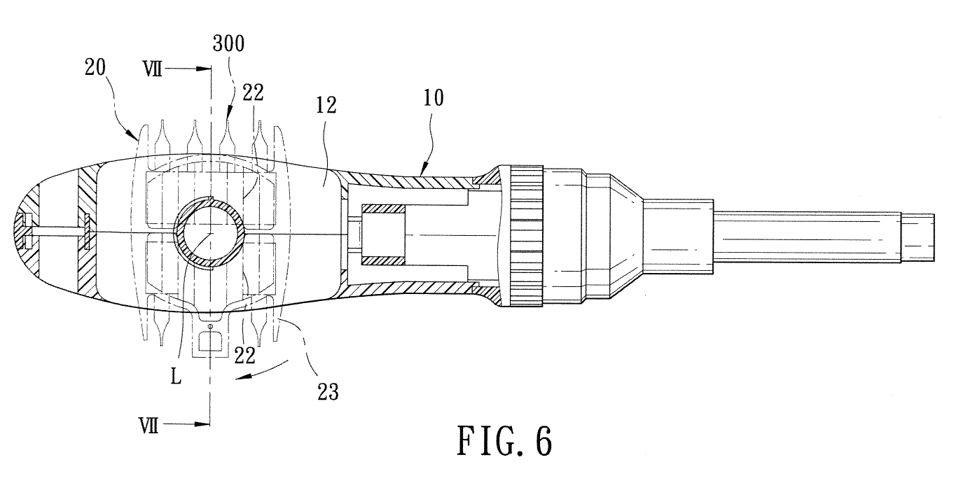

The pivot portion 21 is pivotable relative to the handle body 10 about the pivot axis (L) such that the first bit receiving portion 200 is movable relative to the handle body 10 between a bit concealing position (see FIG. 5), where the bit receiving hole 22 is concealed in the slot 12 of the handle body 10, and a bit accessing position (see FIG. 6), where the bit receiving hole 22 is accessible from the slot 12 in the handle body 10.

In this embodiment, the bit retainer 20 further includes a second bit receiving portion 201 that is formed with at least one bit receiving hole 22, that is connected to the pivot portion 21, and that is disposed opposite to the first bit receiving portion 200 relative to the pivot axis (L). The first and second bit receiving portions 200,201 are movable relative to the handle body 10 between the bit concealing position (see FIG. 5), where the bit receiving holes 22 in the first and second bit receiving portions 200,201 are concealed in the slot 12 of the handle body 10, and the bit accessing position (see FIG. 6), where the bit receiving holes 22 in the first and second bit receiving portions 200,201 are accessible from opposite ends of the slot 12 in the handle body 10.

The bit retainer 20 further includes a pair of shielding plates 23 that are connected to and that are disposed on opposite sides of the first and second bit receiving portions 200,201 relative to the pivot axis (L). The shielding plates 23 cover the opposite ends of the slot 12 in the handle body 10 when the first and second bit receiving portions 200,201 are at the bit concealing position (see FIG. 5), and extend out of the slot 12 when the first and second bit receiving portions 200,201 are at the bit accessing position (see FIG.6).

It is noted herein that the second bit receiving portion 201 of the bit retainer 20 may be omitted in other embodiments of this invention.

The handle 100 further includes a limiting unit provided on the handle body 10 and the bit retainer 20 for limiting range of pivoting movement of the bit retainer 20 relative to the handle body 10. In this embodiment, the limiting unit includes an arcuate slide way 44,54 that is formed in the pivot plates 411,511 and that extends along a periphery of the pivot hole 13, and a stop 24 that is formed on the pivot shaft of the pivot portion 21 and that extends into the slide way 44,54.

The slide way 44,54 has an arc length not greater than 180 degrees. In this embodiment, the slide way 44,54 has an arc length equal to 180 degrees.

In this embodiment, the slide way 44,54 is cooperatively formed by the pivot plates 411,511. In other embodiments, the slide way 44,54 may be formed in only one of the pivot plates 411,511. In yet another embodiment, the stop may be formed on one of the pivot plates 411,511 and the slide way 44,54 may be formed in the pivot shaft of the pivot portion 21.

The handle 100 further includes a positioning unit that includes a first positioning member 45,55 provided on the handle body 10, and a second positioning member 25 that is provided on the bit retainer 20 and that engages removably the first positioning member 45,55 for positioning removably the first bit receiving portion 200 at the bit concealing position. In this embodiment, the first positioning member 45,55 is an indentation cooperatively formed by the pivot plates 411,511, and the second positioning member 25 is a protrusion. In other embodiments, the first positioning member 45,55 may be a protrusion formed on one of the pivot plates 411,511, and the second positioning member 25 may be an indentation formed on the bit retainer 20.

Referring to FIG. 5, when the bit retainer 20 is disposed at the bit concealing position, the second positioning member 25 engages the first positioning member 45,55. Therefore, the bit retainer 20 is not easily removed from the bit concealing position when holding the handle 100. The tool bits 300 in the bit receiving holes 22 can be fully and securely stored in the slot 12 of the handle body 10. More particularly, the presence of the tool bits 300 in the slot 12 does not result in user discomfort since the tool bits 300 are unable to protrude from the slot 12 of the handle body 10 when the bit retainer 20 is at the bit concealing position.

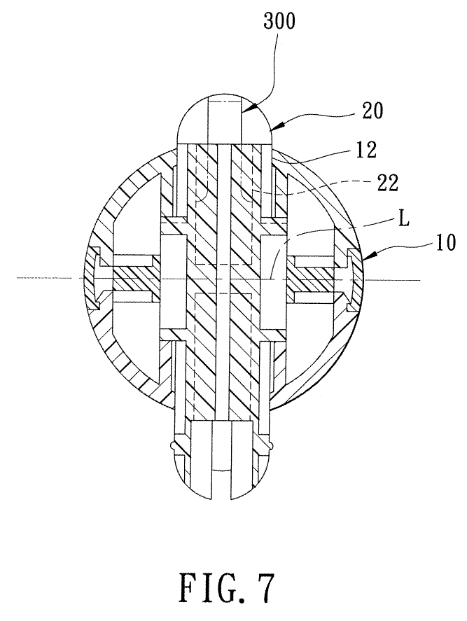

Referring to FIGS. 6 and 7, the bit receiving holes 22 in the first and the second bit receiving portions 200,201 are accessible from the opposite ends of the slot 12 in the handle body 10 when the bit retainer 20 is positioned at the bit accessing position according to this embodiment. Therefore, the tool bits 300 can be easily removed from or inserted into the bit receiving holes 22.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. A handle adapted for storing a tool bit therein, said handle comprising:
a handle body having an outer surface that surrounds a longitudinal axis extending in a first direction and that has opposite surface parts opposite to each other in a second direction transverse to the first direction, said handle body further having a slot formed through said opposite surface parts of said outer surface of said handle body; and
a bit retainer disposed in said slot of said handle body, and including a first bit receiving portion formed with at least one bit receiving hole that is adapted for insertion of the tool bit therein, and a pivot portion connected to said first bit receiving portion and pivotally retained in said slot, said pivot portion being pivotable relative to said handle body about a pivot axis that extends in a third direction transverse to the first and second directions such that said first bit receiving portion is movable relative to said handle body between a bit concealing position, where said at least one bit receiving hole is concealed in said slot of said handle body, and a bit accessing position, where said at least one bit receiving hole is accessible from said slot in said handle body.

2. The handle as claimed in claim 1, wherein said bit retainer further includes a pair of shielding plates that are connected to and that are disposed on opposite sides of said first bit receiving portion relative to the pivot axis, said shielding plates covering opposite ends of said slot in said handle body when said first bit receiving portion is at the bit concealing position, and extending out of said slot when said first bit receiving portion is at the bit accessing position.

3. The handle according to claim 1, wherein said bit retainer further includes a second bit receiving portion that is formed with at least one bit receiving hole, that is connected to said pivot portion, and that is disposed opposite to said first bit receiving portion relative to the pivot axis,
said first and second bit receiving portions being movable relative to said handle body between the bit concealing position, where said bit receiving holes in said first and second bit receiving portions are concealed in said slot of said handle body, and the bit accessing position, where said bit receiving holes in said first and second bit receiving portions are accessible from opposite ends of said slot in said handle body.

4. The handle according to claim 1, wherein said pivot portion of said bit retainer includes a pivot shaft having opposite ends along the pivot axis, and said handle body includes first and second case parts opposite to each other in the second direction, each of said first and second case parts including a case wall through which said slot extends, and a pivot plate that extends from said case wall toward the other of said first and second case parts, said pivot plates of said first and second case parts being formed with notches that cooperate to confine a pivot hole for pivotally retaining one of said opposite ends of said pivot shaft.

5. The handle according to claim 4, wherein said handle body further includes an intermediate frame part disposed between said first and second case parts and formed with a plurality of first locking members, said first and second case parts being formed with a plurality of second locking members to engage said first locking members and connect said first and second case parts to said intermediate frame part, said outer surface of said handle body being cooperatively defined by outer surfaces of said intermediate frame part and said case walls of said first and second case parts.

6. The handle according to claim 5, wherein said handle body further includes a shank coupler connected to one end of said intermediate frame part and adapted for connecting to a tool shank.

7. The handle as claimed in claim 5, wherein one of said first and second locking members is a hole, and the other one of said first and second locking members is a resilient hook part.

8. The handle as claimed in claim 4, further comprising a limiting unit provided on said handle body and said bit retainer for limiting range of pivoting movement of said bit retainer relative to said handle body.

9. The handle as claimed in claim 8, wherein said limiting unit includes an arcuate slide way that is formed in one of said pivot plates and said pivot shaft and that extends along a periphery of said pivot hole, and a stop that is formed on the other one of said pivot plates and said pivot shaft and that extends into said slide way.

10. The handle as claimed in claim 9, wherein said slide way has an arc length not greater than 180 degrees.

11. The handle as claimed in claim 1, further comprising a limiting unit provided on said handle body and said bit retainer for limiting range of pivoting movement of said bit retainer relative to said handle body.

12. The handle as claimed in claim 1, further comprising a positioning unit that includes a first positioning member provided on said handle body, and a second positioning member that is provided on said bit retainer and that engages removably said first positioning member for positioning removably said first bit receiving portion at the bit concealing position.

13. The handle as claimed in claim 12, wherein one of said first and second positioning members is an indentation, and the other one of said first and second positioning members is a protrusion.
